(19) United States
(12) Patent Application Publication
(10) Pub. No.: US 2026/0233529 A1
(43) Pub. Date: Aug. 13, 2026

(54) INKJET PRINTING SYSTEMS AND METHODS FOR CONTROLLED, NON-IMAGING INKJET PURGING

(71) Applicant: Xerox Corporation, Norwalk, CT (US)

(72) Inventors: Douglas K. Herrmann, Webster, NY (US); Anthony S. Condello, Webster, NY (US); Seemit Praharaj, Marlborough, NH (US); Jason M. LeFevre, Penfield, NY (US); Peter M. Gulvin, Webster, NY (US); Varun Sambhy, Pittsford, NY (US); Mark C. Petropoulos, Webster, NY (US); Christine A. Steurrys, Williamson, NY (US); Nicholas David Stucchi, Greece, NY (US)

(73) Assignee: Xerox Corporation, Norwalk, CT (US)

(21) Appl. No.: 19/051,807

(22) Filed: Feb. 12, 2025

(51) Int. Cl. B41J 2/165; B41J 2/17; B41J 2/175

(52) U.S. Cl. CPC B41J 2/1652; B41J 2/1721; B41J 2/17563

(57) ABSTRACT

Provided herein are inkjet printing systems and methods for preventing inkjet degradation in such inkjet printing systems. The systems and methods described herein may be applied to a number of different types of printing systems, but may find particular application in connection with cut-sheet production inkjet printing systems where there is continuous short edge printing. According to various embodiments, the printing systems comprise one or more printheads staggered in a cross-process direction and a media transport system configured to collect non-imaging ink droplets jetted from unused inkjets.

### FIELD OF THE DISCLOSURE

The present disclosure relates generally to inkjet printing systems, and more specifically to systems and methods for preserving inkjet health in such inkjet printing systems via controlled, non-imaging inkjet purges.

### BACKGROUND

Inkjet printheads, such as piezoelectric printheads, are crucial components of inkjet printing systems and are responsible for transferring ink onto a print media substrate to create text and/or images. These printheads work by ejecting tiny droplets (e.g., on the order of several to tens of picoliters, a picoliter being one trillionth of a liter) through microscopic nozzles, which are arranged in an array. Each nozzle is connected to an ink chamber that holds the ink before ejection. A set of actuators are responsible for creating the pressure pulse that forces the ink out of the nozzles. Piezoelectric actuators are common and employ piezoelectric crystals that changes shape when an electric charge is applied, creating a pressure pulse

In operation, an electric charge is applied to the piezoelectric crystal, causing it to flex and create a pressure pulse. This pulse pushes a droplet of ink out of the nozzle. When the charge is removed, the crystal returns to its original shape, drawing more ink into the chamber. The printhead is controlled by electronic circuits that manage the timing and sequence of droplet ejection to ensure accurate printing

A single inkjet printing system may contain one or more distinct printheads, and each printhead may contain hundreds or thousands of individual inkjet nozzles arranged in a compact patterned printing array (e.g., within less than a 2 inch by 6 inch area). One or more printheads may be stationary while the print media moves below them, or may move across the print media substrate to deposit ink at specific locations and form the desired print.

While advancements in inkjet printhead technologies have enabled significantly improved image generation and faster printing speeds, there are a number of drawbacks to these printing systems. For example, aqueous inks formulated for piezoelectric inkjet applications typically comprise a significant amount of water (e.g., 50-65%), which makes these inks highly susceptible to drying out. At the nozzle level inside a piezoelectric inkjet printhead, this drying out can result in the formation of viscous plugs, cause intermittent, weak, misdirected, and/or missing jets resulting in runtime image quality issues, pigment agglomeration/falling out from suspension due to unstable ink formulation, as well as permanent changes in the aperture surface characteristics due to continuous contamination.

### SUMMARY OF THE DISCLOSURE

The systems and methods provided herein improve inkjet printing performance by preserving inkjet health and preventing drying out of printhead nozzles. As described in more detail below, embodiments of the present disclosure provide controlled, non-imaging inkjet purges that pass through the perforated transport belt and to an ink-collecting device.

According to an embodiment of the present disclosure, a method for preserving inkjet health in an inkjet printing system is provided. The inkjet printing system can include a media transport module configured to transport a print media substrate through a print zone and an inkjet printhead configured to eject ink droplets from one or more inkjet nozzles in the print zone. The method can include: detecting, via the inkjet printing system, a position of a transport belt of the media transport module; determining, based on the detected position of the transport belt, a location of a transport belt hole of the transport belt; and ejecting, from the one or more inkjet nozzles of the printhead, an ink droplet based on the determined location of the transport belt hole of the transport belt. The ink droplet(s) can be ejected such that the ink droplet passes through the transport belt hole of the transport belt.

In an aspect, the method can further include: determining, based on the detected position of the transport belt, a location of a plurality of transport belt holes of the transport belt; and ejecting, from the one or more inkjet nozzles of the printhead, a plurality of ink droplets based on the determined locations of the plurality of transport belt holes of the transport belt. Each ink droplet of the plurality of ink droplets can be ejected such that the ink droplet passes through one of the plurality of transport belt holes of the transport belt.

In an aspect, the transport belt can include a plurality of transport belt holes arranged linearly in a cross-process direction and extend across at least a portion of the transport belt corresponding to an inboard portion of the printhead.

In an aspect, the inkjet printing system can include a belt registration sensor configured to detect the position of the transport belt of the media transport module.

In an aspect, the method can further include: receiving, by the inkjet printing system, a print job to be completed by the inkjet printing system; and completing the print job by: (i) transporting one or more print media substrates through the print zone based on the received print job; and (ii) ejecting, from the one or more inkjet nozzles of the printhead, a plurality of ink droplets onto the one or more print media substrates within the print zone; and while completing the print job: (i) determining, based on the print job, an inactive inkjet nozzle among the one or more inkjet nozzles; and (ii) ejecting, from the inactive inkjet nozzle, a non-imaging ink droplet based on the determined location of the transport belt hole of the transport belt. The non-imaging ink droplet(s) can be ejected from the inactive inkjet nozzle such that the non-imaging ink droplet passes through the transport belt hole of the transport belt.

In an aspect, the inactive inkjet nozzle is determined by: calculating a projected duration of non-use for each of the one or more inkjet nozzles during the print job; and identifying each of the one or more inkjet nozzles having a projected duration of non-use that exceeds a threshold, wherein at least one inkjet nozzle has a projected duration of non-use that exceeds the threshold and is identified as the inactive inkjet nozzle.

According to another embodiment of the present disclosure, an inkjet printing system is provided. The inkjet printing system can include: (i) a media transport module comprising a transport belt and configured to transport a print media substrate through a print zone of the inkjet printing system; (ii) an inkjet printhead comprising a plurality of inkjet nozzles and configured to eject ink droplets from the plurality of inkjet nozzles in the print zone; and (iii) a print engine operatively connected to the media transport module and the inkjet printhead, wherein the print engine comprises one or more processors in communication with a non-transitory computer-readable storage medium having stored thereon instructions that, when executed by the one or more processors, cause the inkjet printing system to perform the following operations: detect a position of the transport belt of the media transport module; determine, based on the detected position of the transport belt, a location of a transport belt hole of the transport belt; and eject, from at least one inkjet nozzle of the plurality of inkjet nozzles, an ink droplet based on the determined location of the transport belt hole of the transport belt. The ink droplet(s) can be ejected such that the ink droplet passes through the transport belt hole of the transport belt.

In an aspect, the non-transitory computer-readable storage medium further comprises instructions stored thereon that, when executed by the one or more processors, cause the inkjet printing system to perform the following operations: determine, based on the detected position of the transport belt, a location of a plurality of transport belt holes of the transport belt; and eject, from the at least one inkjet nozzle of the plurality of inkjet nozzles, a plurality of ink droplets based on the determined locations of the plurality of transport belt holes of the transport belt. Each ink droplet of the plurality of ink droplets can be ejected such that the ink droplet passes through one of the plurality of transport belt holes of the transport belt.

In an aspect, the transport belt can include a plurality of transport belt holes arranged linearly in a cross-process direction.

In an aspect, the plurality of transport belt holes can extend across only a portion of the transport belt corresponding to an inboard portion of the printhead.

In an aspect, the plurality of transport belt holes can extend across an entire width of the transport belt.

In an aspect, the inkjet printing system can further include (iv) a belt registration sensor configured to detect the position of the transport belt of the media transport module.

In an aspect, the media transport module can further include: one or more air blowers configured to apply a vacuum pressure through the transport belt in order to secure the print media substrate to the transport belt; a vacuum plate disposed below the transport belt and having a plurality of holes and/or slots (i.e., one or more vacuum plenums), the vacuum plate being configured to support the transport belt while maintaining the vacuum pressure; and a purge platform disposed below the vacuum plate and comprising one or more cross-process purge plenums configured to collect one or more ink droplets ejected through the transport belt hole of the transport belt.

In an aspect, the purge platform and the one or more cross-process purge plenums can be stationary during operation of the inkjet printing system.

In an aspect, the media transport module can further include: one or more air blowers configured to apply a vacuum pressure through the transport belt in order to secure the print media substrate to the transport belt; a vacuum plate disposed below the transport belt and having a plurality of holes and/or slots, the vacuum plate being configured to support the transport belt while maintaining the vacuum pressure; and a porous filter belt disposed below the vacuum plate within the print zone, wherein the porous filter belt comprises a porous ink-absorbing material configured absorb one or more ink droplets ejected through the transport belt hole of the transport belt whiling maintain the vacuum pressure.

In an aspect, the porous filter belt can be movable relative to the vacuum plate and the transport belt such that different portions of the porous filter belt may be exposed to the print zone at different times.

According to an aspect of the present disclosure, a media transport module for use in an inkjet printing system is provided. The media transport module can include: (i) a transport belt comprising a plurality of transport belt holes, wherein the transport belt is configured to transport a print media substrate through a print zone of the inkjet printing system; (ii) one or more air blowers configured to apply a vacuum pressure through the transport belt in order to secure the print media substrate to the transport belt; (iii) a vacuum plate disposed below the transport belt and having a plurality of holes and/or slots, the vacuum plate being configured to support the transport belt while maintaining the vacuum pressure; and (iv) an ink-collecting means disposed below the vacuum plate and configured to collect one or more ink droplets ejected by a printhead of the inkjet printing system and received through a transport belt hole of the plurality of transport belt holes.

In an aspect, the ink-collecting means can include a purge platform disposed below the vacuum plate and comprising one or more cross-process purge plenums configured to collect one or more ink droplets ejected through the transport belt hole of the transport belt. The purge platform and the one or more cross-process purge plenums are stationary.

In an aspect, the ink-collecting means can include a porous filter belt disposed below the vacuum plate within the print zone, wherein the porous filter belt comprises a porous ink-absorbing material configured absorb one or more ink droplets ejected through the transport belt hole of the transport belt whiling maintain the vacuum pressure. The porous filter belt can be movable relative to the vacuum plate and the transport belt such that different portions of the porous filter belt may be exposed to the print zone at different times

In an aspect, the ink-collecting means can extend across at least a portion of the transport belt corresponding to an inboard portion of the printhead, and/or the ink-collecting means can extend across an entire width of the transport belt.

These and other aspects of the various embodiments will be apparent from and elucidated with reference to the embodiments described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a block diagram of a production inkjet printing system illustrated in accordance with aspects of the present disclosure.

FIG. 2A is a block diagram of a media transport system illustrated in accordance with aspects of the present disclosure.

FIG. 2B is a diagram of a print engine and media transport system illustrated in accordance with aspects of the present disclosure.

FIG. 3 is a block diagram of a printer controller illustrated in accordance with aspects of the present disclosure.

FIG. 4 is an illustration of a print engine and media transport system shown in accordance with a first embodiment of the present disclosure.

FIG. 5A is another illustration of a print engine and media transport system shown in accordance with the first embodiment of the present disclosure.

FIG. 5B is an illustration of a media transport belt shown in accordance with certain aspects of the present disclosure.

FIG. 6 is still another illustration of a print engine and media transport system shown in accordance with the first embodiment of the present disclosure.

FIG. 7 is an illustration of a print engine and media transport system shown in accordance with a second embodiment of the present disclosure.

FIG. 8 is an illustration of a porous filter system shown in accordance with the second embodiment of the present disclosure.

FIG. 9 is another illustration of a porous filter system shown in accordance with the second embodiment of the present disclosure.

FIG. 10 is a flowchart of a method for controlled purging of non-imaging inkjets illustrated in accordance with aspects of the present disclosure.

### DETAILED DESCRIPTION OF EMBODIMENTS

As described herein, it is appreciated that in various types of inkjet printing systems, the printhead inkjets will dry out if not used regularly, which causes clogging of the inkjets among other issues. These degraded inkjets in turn cause issues with print quality, such as noisy streaks due to drop misplacement (i.e., increased drop placement error), or a noticeable streak artifact through the printed image. One technique for addressing this problem in inkjet printing systems is known as background spray, sometimes referred to a “sneezing,” which is a technique where one or more inkjets on the printhead are fired occasionally without regard to the image content of the print job, resulting in a very sparse drop pattern on the sheet. The drop pattern is sufficiently sparse that the drops are not very noticeable on the printed media under casual observation.

However, it is not always possible or appropriate for the unused inkjets to “sneeze” onto a print media. For example, inkjets should not “sneeze” directly onto the transport belt, thus, it may not be possible to “sneeze” when the width of the print media is too narrow. In other cases, a higher quality image is desired, and therefore it may not be suitable to have the unused inkjets “sneeze” onto the print media even when the print media is within range of the unused inkjets.

Accordingly, provided herein are systems and methods for preserving inkjet health by preventing drying out of printhead nozzles. The embodiments of the present disclosure provide controlled, non-imaging inkjet purges and thereby improve upon these and other drawbacks in the technology. As described in more detail below, the printing systems of the present disclosure preferably include ink-collecting means disposed below the print engine and configured to collect the non-imaging ink droplets.

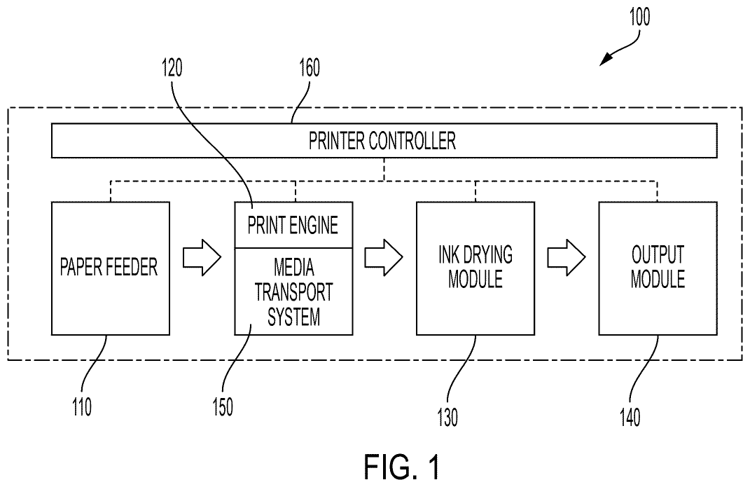

Turning to FIG. 1, a generalized block diagram of a printing system 100 is shown according to aspects of the present disclosure. In embodiments, the inkjet printing system 100 may be a digital printing press, such as a high-performance, cut-sheet inkjet printing system. The printing system 100 may also be a high-volume and high-quality inkjet printing system. In particular embodiments, the printing system 100 may be referred to as a production inkjet (PIJ) system. For example and without limitation, the printing system 100 may be a Xerox Baltoro™ HF Inkjet Press, or a similar printing system.

As shown in the example of FIG. 1, the printing system 100 generally includes a cut-sheet paper feeder module 110, a print engine module 120, an ink drying module 130, an output module 140, a media transport system 150, and a printer controller 160.

The paper feeder module 110 is configured to store various types of print media and convey the print media to the print engine 120 via the media transport system 150. In embodiments, the paper feeder module 110 can include one or more cassettes or trays and adjustable leveling assemblies configured to move the sheets of print media into proper position when needed for a particular print job. In embodiments, the print media can include, but is not limited to, uncoated plain paper, inkjet treated or inkjet coated paper, offset coated paper, as well as uncoated and/or un-primed paper. In further embodiments, the print media can have different sizes. For example, the feeder module 110 may allow for a maximum media width of approximately 14 inches (inboard-to-outboard direction). However, some print jobs will require media that is less than the full 14 inches wide (e.g., 12 inches for a 12″×18″ media is a common size in the print industry). In this narrow media printing scenario, the paper in the printing system 100 is generally outboard registered (i.e., aligned with the outboard edge of the media transport system 150).

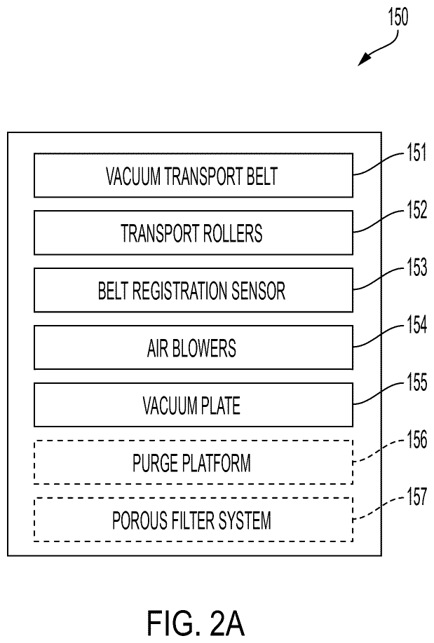

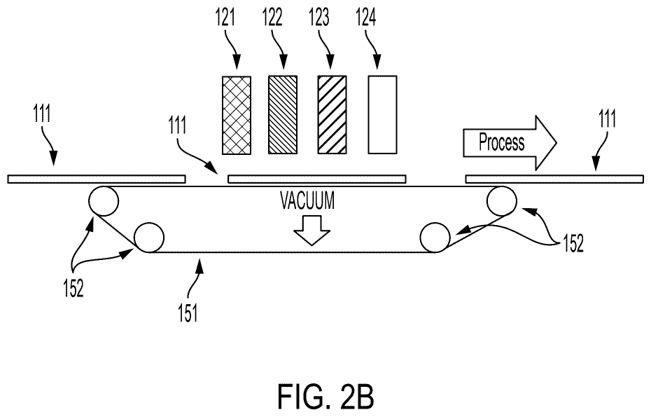

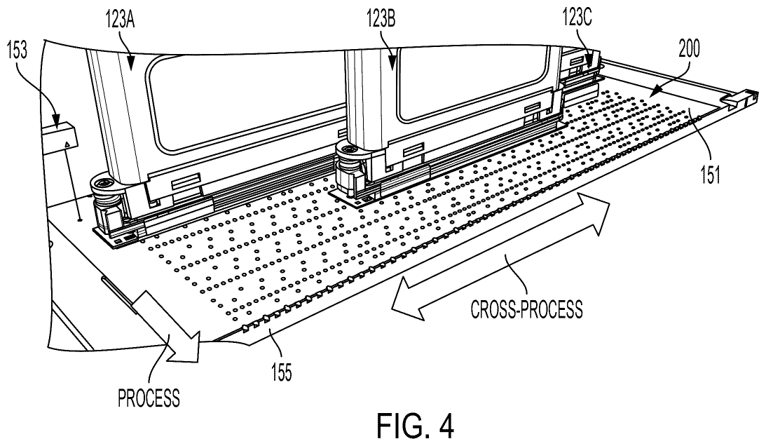

The print engine 120 is configured to eject ink droplets from one or more inkjet printheads (e.g., printheads 121, 122, 123, 124 shown in FIG. 2B) on the print media (e.g., print media 111 shown in FIG. 2B) as it passes through a printing zone via the media transport system 150. In embodiments, the print engine 120 comprises one or more print bar assemblies, each print bar assembly comprising a printhead mounting plate and one or more inkjet printheads 121, 122, 123, 124 mounted thereon. The one or more inkjet printheads can be operatively connected to one or more ink reservoirs. Although only one printhead 121, 122, 123, 124 of each ink type is shown in FIG. 2B, it should be appreciated that there may be multiple of each such printheads (e.g., printheads 123A, 123B, 123C shown in FIG. 4). Each printhead of the print engine 120 can include a plurality of individual inkjets that can be individually controlled in order to recreate the desired image content of a print job.

In embodiments, each print bar assembly may comprise one or more printheads configured to eject ink droplets of a particular color (e.g., magenta, cyan, yellow, and black) within the printing zone. In specific embodiments, the print engine 120 can include four print bar assemblies, each having three separate inkjet printheads for a total of 12 printheads. In further embodiments, the inkjet printheads may be piezoelectric printheads having hundreds or thousands of individually-addressable piezoelectric inkjets.

The ink drying module 130 is configured to apply heat and/or pressure to the print media to dry the jetted ink and fuse the jetted ink onto the print media. In embodiments, the ink drying module 130 may be referred to as a fuser. The ink drying module 130 can include one or more drying lamps that are used to dry the ink in a “non-contact” manner.

The output module 140 is configured to present the finished print media for retrieval. In embodiments, the output module 140 can include a stacker that stacks the finished print media.

Optionally, the printing system 100 can also include a finishing module (not shown) that is configured to apply various finishing details to a print job. In embodiments, these finishing details can include, for example, stappling, hole punching, binding, lamination, and/or the like, including combinations thereof.

In embodiments, the media transport system 150 is configured to receive print media from the feeder module 110 and convey the print media through a printing zone defined by the print engine 120 and then finally to the ink dry module 130 and/or the output module 140. As shown in the examples of FIGS. 2A and 2B, the media transport system 150 can include a transport belt 151 mounted on one or more transport rollers 152 configured to move the transport belt 151 in a process direction. As the print media moves in a process direction through a printing zone defined by the print engine 120, the inkjets of the inkjet printheads are operated to eject ink droplets in a controlled manner to recreate an image on the print media.

In embodiments, the transport belt is a perforated transport belt 151 having a plurality of belt holes that are arranged in one or more perforation patterns. The media transport system 150 can include a belt registration sensor 153 configured to detect the position of the transport belt 151, which can be used to determine the exact positions of one or more belt holes. The media transport system 150 can also include one or more air blowers 154 and a vacuum plate 155 disposed below the transport belt 151. The air blowers 154 can be configured to generate a vacuum pressure through a plurality of holes or slots in the vacuum plate 155 and a plurality of holes in the transport belt 151 in order to secure the sheets of print media to the transport belt 151 as the transport belt 151 conveys the print media through the printing zone of the print engine module 120. As discussed in more detail below, the media transport system 150 may also include, in certain embodiments, a purge platform 156 and/or a porous filter system 157.

The printing system 100 can also include a printer controller 160 configured to implement a printing path schedule based on one or more print orders. In embodiments, the printer controller 160 is configured to operate the different components of the printing system 100, including but not limited to, the feeder module 110, the print engine 120, the ink drying module 130, the output module 140, and the media transport system 150.

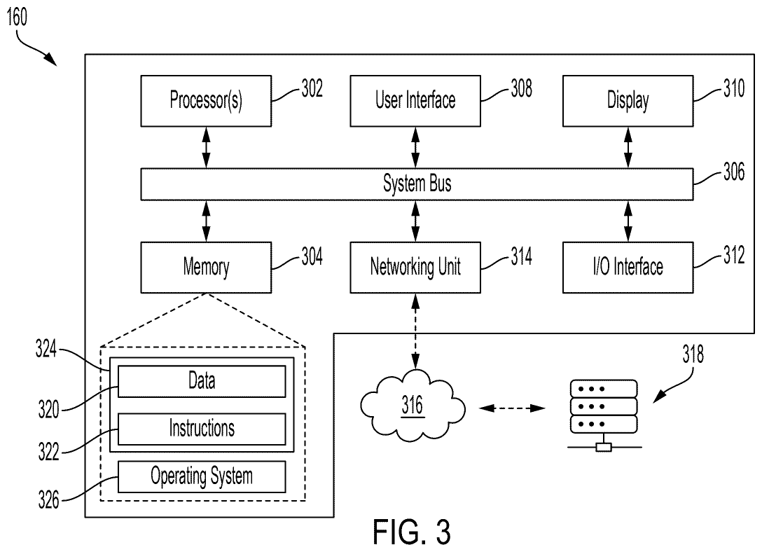

For example, with reference to FIG. 3, the printer controller 160 can include one or more processors 302 and a computer-readable memory 304 interconnected and/or in communication via a system bus 306 containing conductive circuit pathways through which instructions (e.g., machine-readable signals) may travel to effectuate communication, tasks, storage, and the like. The printer controller 160 can be connected to a power source (not shown), which can include an internal power supply and/or an external power supply. In embodiments, the printer controller 160 can also include one or more additional components, such as a user interface 308, a display 310, an input/output (I/O) interface 312, a networking unit 314, and the like, including combinations thereof. As shown, each of these components may be interconnected and/or in communication via the system bus 306, for example.

In embodiments, the one or more processors 302 can include one or more high-speed data processors adequate to execute the program components described herein and/or perform one or more operations of the methods described herein. The one or more processors 302 may include a microprocessor, a multi-core processor, a multithreaded processor, an ultra-low voltage processor, an embedded processor, and/or the like, including combinations thereof. The one or more processors 302 can include multiple processor cores on a single die and/or may be a part of a system on a chip (SoC) in which the processor 302 and other components are formed into a single integrated circuit, or a single package. That is, the one or more processors 302 may be a single processor, multiple independent processors, or multiple processor cores on a single die.

In embodiments, the user interface 308 may be configured to receive various forms of input from a user associated with the printing system 100. The user interface 308 can include, but is not limited to, one or more of a keyboard, keypad, trackpad, trackball(s), capacitive keyboard, controller (e.g., a gaming controller), computer mouse, computer stylus/pen, a voice input device, and/or the like, including combinations thereof.

In embodiments, the display device 310 may be configured to display information, including text, graphs, and/or the like. The display device 310 can include, but is not limited to, a liquid crystal display (LCD), a light-emitting diode (LED) display, a touch screen or other touch-enabled display, a foldable display, a projection display, and so on, or combinations thereof.

In embodiments, the input/output (I/O) interface 312 may be configured to connect and/or enable communication with one or more peripheral devices (not shown), including but not limited to additional machine-readable memory devices, diagnostic equipment, and other attachable devices. The I/O interface 312 may include one or more I/O ports that provide a physical connection to the one or more peripheral devices. In some embodiments, the I/O interface 312 may include one or more serial ports.

In embodiments, the networking unit 314 may include one or more types of networking interfaces that facilitate wired and/or wireless communication between the printing system 100 and one or more external devices. That is, the networking unit 314 may operatively connect the printer controller 160 to one or more types of communications networks 316, which can include a direction interconnection, the Internet, a local area network (“LAN”), a metropolitan area network (“MAN”), a wide area network (“WAN”), a wired or Ethernet connection, a wireless connection, a cellular network, Bluetooth®, and similar types of communications networks, including combinations thereof. In some embodiments, the printer controller 160 may communicate with one or more remote/cloud-based servers and/or cloud-based services, such as remote server 318, via the communications network 316.

In embodiments, the memory 304 can be variously embodied in one or more forms of machine accessible and machine-readable memory. In some embodiments, the memory 304 can be a storage device, which can include, but is not limited to, a non-transitory storage medium, a magnetic disk storage, an optical disk storage, an array of storage devices, a solid-state memory device, and/or the like, as well as combinations thereof. The memory 304 may also include one or more other types of memory, such as dynamic random-access memory (DRAM), static random-access memory (SRAM), erasable programmable read-only memory (EPROM), electrically erasable programmable read-only memory (EEPROM), Flash memory, and/or the like, as well as combinations thereof. In embodiments, the memory 304 may include one or more types of transitory and/or non-transitory memory.

The printer controller 160 can be configured by software components stored in the memory 304 to perform one or more processes of the methods described herein. More specifically, the memory 304 can be configured to store data/information 320 and computer-readable instructions 322 that, when executed by the one or more processors 302, causes the printing system 100 to perform controlled, non-imaging inkjet purging. Such data 320 and the computer-readable instructions 322 stored in the memory 304 may form a non-imaging inkjet purge package 324 that may be incorporated into, loaded from, loaded onto, or otherwise operatively available to and from the printer controller 160. Thus, in some embodiments, the non-imaging inkjet purge package 324 and/or one or more individual software packages may be stored in a local storage device of the memory 304. However, in other embodiments, the non-imaging inkjet purge package 324 and/or one or more individual software packages may be loaded onto and/or updated from a remote server or service, such as server 318, via the communications network 316.

Accordingly, provided herein is a computer program product 324 comprising a non-transitory computer-readable storage medium 304 having stored thereon computer-readable instructions 322 that, when executed by one or more processors (such as processors 302), cause the one or more processors to perform one or more operations of the methods described herein.

The printer controller 160 may also include an operating system component 326, which may be stored in the memory 304. The operating system component 326 may be an executable program facilitating the operation of the printing system 100. Typically, the operating system component 326 can facilitate access of the I/O interface 312, network interface 314, the user interface 308, and the display 310, and can communicate or control other components of the printing system 100.

As mentioned above, the media transport system 150 may also include an ink-collecting means disposed below the vacuum plate 155 and configured to collect one or more non-imaging ink droplets ejected by a printhead (e.g., printheads 123A, 123B, 123C). These non-imaging ink droplets can be jetted through one or more holes 200 of the transport belt 151. In specific embodiments, the ink-collecting means can include a purge platform 156, a porous filter belt 157, and/or a similar subsystem.

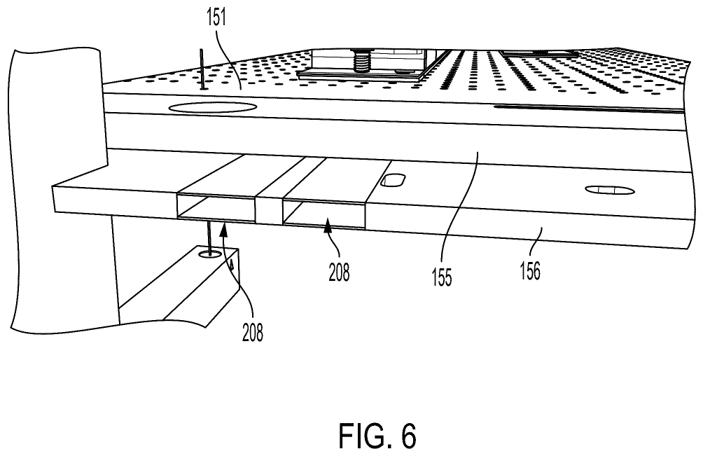

For example, with reference to FIGS. 4 to 6, one embodiment of a printing system 100 comprising a media transport system 150 having a purge platform 156 is illustrated in accordance with certain aspects of the present disclosure. As shown in these examples, the media transport system 150 is configured to transport sheets of print media under one or more printheads 123A, 123B, 123C in a process direction. The media transport system 150 comprises a perforated transport belt 151 having a plurality of holes 200 extending in a cross-process direction. Disposed below the transport belt 151 (relative to the printheads 123A, 123B, 123C) is a vacuum plate 155 configured to support the belt 151 as a vacuum pressure is applied from below. The media transport system 150 also comprises a belt registration sensor 153 configured to track and monitor the exact position of the transport belt 151.

According to this embodiment, the media transport system 150 further comprises a purge platform 156 disposed below the vacuum plate 155 (relative to the printheads 123A, 123B, 123C). The purge platform 156 can include one or more purge plenums 208 positioned so as to be directly below the printheads (e.g., printheads 123A, 123B, 123C). The purge plenums 208 can be configured to collect a plurality of non-imaging ink droplets ejected by a printhead (e.g., printheads 123A, 123B, 123C). In embodiments, the vacuum pressure may also be applied to the purge platform 156 and the purge plenums 208. In particular embodiments, the purge plenums 208 can comprise a replaceable purge drop filter, container, or other absorbent material in order to collect the non-imaging purge ink droplets for later disposal.

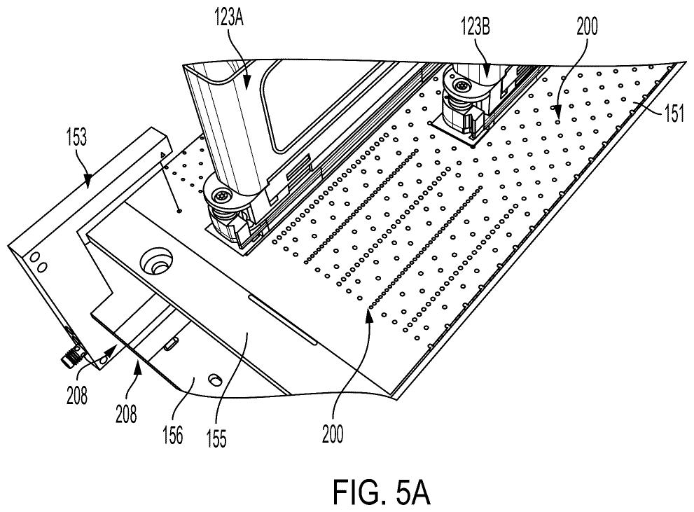

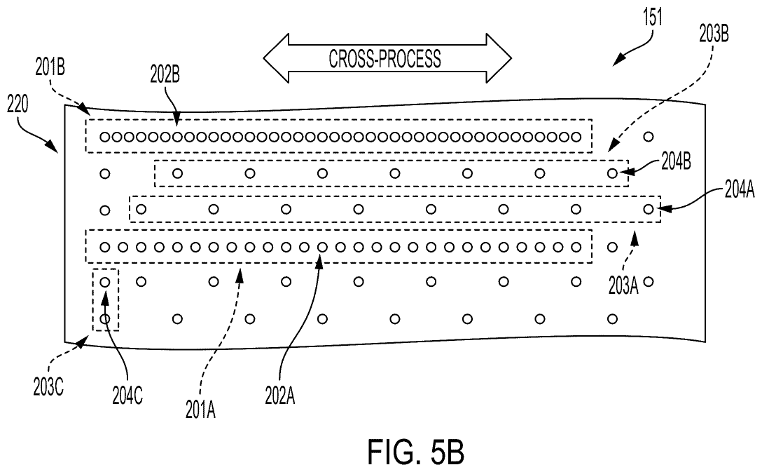

With specific reference to FIG. 5B, a portion of a transport belt 151 of the media transport system 150 is illustrated, wherein the transport belt 151 includes one or more distinct arrangements/patterns of holes 200. The transport belt 151 may include one or more arrangements/patterns 201A, 201B comprising a plurality of purge holes 202A, 202B, and one or more arrangements/patterns 203A, 203B, 203C comprising a plurality of vacuum holes 204A, 204B, 204C. In embodiments, the purge holes 202A, 202B and the arrangements 201A, 201B thereof are configured to provide ink jetting coverage for each of the inkjets of the printheads 121, 122, 123, 124. That is, each inkjet of the printheads 121, 122, 123, 124 has a known jetting spread or range within which ink may be jetted, and the purge holes 202A, 202B and the arrangements 201A, 201B thereof are provided so that one or more purge holes 202A, 202B are within jetting range of each inkjet.

In embodiments, the vacuum holes 204A, 204B, 204C may be provided to communicate a vacuum pressure to the print media 111 disposed on the transport belt 151, thereby securing the print media 111 to the transport belt 151. Unlike the vacuum holes 204A, 204B, 204C, the purge holes 202A, 202B may not be used for print media hold down. That is, the purge holes 202A, 202B can, at times, align with the vacuum plenums, the only time the purge holes 202A, 202B are used for the removal of non-imaging ink droplets is when the purge holes 202A, 202B are aligned with cross-process purge plenums 208 of the purge platform 156.

In the example of FIG. 5B, the transport belt 151 includes at least a first arrangement 201A of a plurality of purge holes 202A and at least a first arrangement 203A of a plurality of vacuum holes 204A. The transport belt 151 may also include additional arrangements of purge holes and/or vacuum holes, such as at least a second arrangement 201B of a plurality of purge holes 202B, at least a second arrangement 203B of a plurality of vacuum holes 204B, and/or at least a third arrangement 203C of a plurality of vacuum holes 204C.

In embodiments, the arrangements 201A, 201B, 203A, 203B may have a plurality of holes 202A, 202B, 204A, 204B arranged in rows aligned linearly in a cross-process direction. In embodiments, these arrangements 201A, 201B, 203A, 203B may be characterized based on the diameter of the holes, the offset of the holes, and/or the linear density of the holes.

In embodiments, each of the holes 202A, 202B, 204A, 204B, 204C may have a hole diameter of between about 1 mm and about 3 mm, including about 1.8 mm.

In embodiments, the vacuum holes 204A, 204B of the arrangements 203A, 203B may be offset in a cross-process direction by from about 10 mm to about 20 mm, and/or can have a linear density of less than about 0.1 holes/mm, including less than about 0.05 holes/mm. Each arrangement 203A, 203B may additionally be offset in a process direction by from about 5 mm to about 20 mm.

In particular embodiments, the arrangements 203A, 203B may extend the entire and/or a substantial portion (at least 90%) of the cross-process width of the transport belt 151, which may be, for example, between 300 mm and 600 mm. In particular embodiments, the transport belt 151 may also include a third arrangement 203C of vacuum holes 204C positioned along an inboard side 220 and/or an outboard side of the transport belt 151. This arrangement 203C of vacuum holes 204C may be offset in a process direction (rather than a cross-process direction).

In further embodiments, the purge holes 202A, 202B of the arrangements 201A, 201B may be offset in a cross-process direction by from about 1 mm to about 5 mm, and can have a linear density of between about 0.1875 to about 0.75 holes/mm. In embodiments, the arrangements 201, 201B may only extend across a portion of the cross-process width of the transport belt 151, such as about 50 mm to about 120 mm, or about 10% to about 30% of the cross-process width of the transport belt 151. In other embodiments, the arrangements 201A, 201B may extend across the entire and/or a substantial portion (at least 90%) of the cross-process width of the transport belt 151.

In still further embodiments, each of the arrangements 201A, 201B of purge holes 202A, 202B may differ in one or mor features, including hole diameter, offset, and/or linear density. For example, in embodiments, the first arrangement 201A of purge holes 202A may have a first hole offset of about 3.18 mm and a first linear density of about 0.3375 holes/mm, whereas the second arrangement 201B of purge holes 202B may have a second hole offset of about 2.11 mm and a second linear density of about 0.5 holes/mm.

Although only a portion of the transport belt 151 is shown in FIG. 5B, it should be appreciated that one or more of the arrangements 201A, 201B, 203A, 203B, 203C can be repeated over the length of the transport belt 151 in the process direction.

Accordingly, as described herein, the transport belt 151 can comprise at least one distinct arrangement 201A, 201B of purge holes 202A, 202B in the transport belt 151 for use by the printing system 100 to perform controlled, non-imaging inkjet purges. These purge holes 202A, 202B may be arranged such that at certain (determinable) times, the holes 202A, 202B align with the purge plenums 208 so as to enable collection of purged ink droplets through the holes 202A, 202B.

That is, as described above, because the narrow print media may not be present under the inkjets during extended runs (i.e., small width media that does not engage all printheads), the inkjets along an inboard side 220 of the printing system 100 can be exercised according to the present disclosure by jetting or sneezing through the purging holes 202A, 202B in order to maintain inkjet health. In this manner, the ink would not be jetted directly onto the belt 151 and clogging of the inkjet heads/nozzles can be prevented.

In embodiments, the distinct arrangements 201A, 201B of purges holes 202A, 202B in the transport belt 151 may be asynchronous, i.e., arranged at different intervals along the process direction and timed to handle varying inter document gaps. It should be understood that during a continuous printing production, a multitude (e.g., hundreds or thousands, sometimes more than ten-thousand, etc.) of print media will be fed through the printing system 100. In order to precisely print on these media, the printing system 100 will register and track the location of each sheet. Between each sheet of print media, there will be an “inter document gap” (sometimes referred to as an “inter document zone”) where there is no print media disposed on the transport belt 151. In this respect, the arrangements 201A, 201B of holes 202A, 202B in the transport belt 151 may be arranged asynchronously such that one or more holes 202A, 202B will be present even if the inter document gap changes. This advantageously allows the purge holes 202A, 202B to be utilized for receiving non-imaging ink droplets as described herein regardless of the media length or width.

In still further embodiments, the purging holes 202A, 202B may be distinctly arranged on the transport belt 151 to correspond to the non-printing inboard side 220 of the printheads (e.g., printheads 123A, 123B, 123C). In particular embodiments, the purging holes 202A, 202B may be arranged 201A, 201B in an asymmetric and/or asynchronous hole pattern within a transport belt 151.

In particular embodiments, such as the example shown in FIG. 5A, the purging holes 202A, 202B may only extend a certain cross-process width from the inboard edge 220 of the printing system 100, and do not extend the full cross-process width of the transport belt 151. However, as shown in FIG. 4, it is also contemplated that the purging holes 202A, 202B may extend the full or a substantial portion (at least 90%) of the cross-process width of the transport belt 151.

As described herein, by registering the position of the transport belt 151 (e.g., via the belt registration sensor 153) and timing the jetting of non-imaging ink droplets from the unused portions of the printheads, the printing system 100 may perform controlled, non-imaging inkjet purges such that the non-imaging ink droplets pass through the purge holes 202A, 202B and are collected by the purge platform 156 without landing on the transport belt 151 itself. In accordance with aspects of the present disclosure, the asynchronous pattern 201A, 201B allows for the holes 202A, 202B to align with the inkjets within an inter document zone between print media based on the timing of the belt 151. Because different media lengths will impact where the inter document zone falls, by making the pattern asynchronous, a portion of the hole patterns 201A, 201B will statistically fall within an inter document zone during any run of any size print media. Further, the holes 202A, 202B do not have to be present in each inter document zone to effectively allow for the purge operation. Additionally, the asymmetric pattern allows for a printing system 100 where a hole pattern 201A, 201B can be placed without adding holes to the entire belt matrix of holes 200. This allows for the belt 151 to be specifically designed to provide coverage to the inboard printheads (e.g., printhead 123A) or to be designed to take on a larger amount of the belt 151.

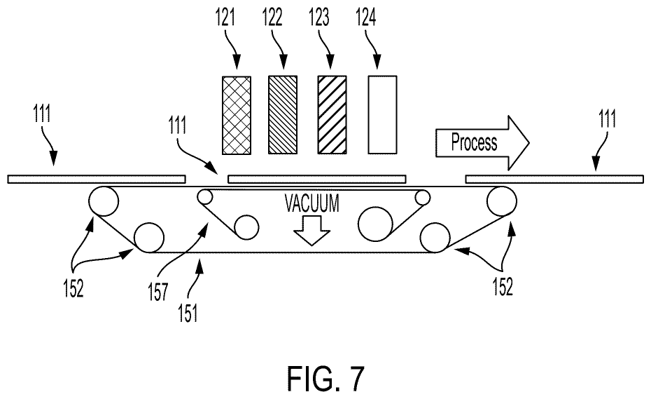

According to another embodiment of the present disclosure, the ink-collecting means of the media transport system 150 can be a porous filter system 157. For example, with reference to FIGS. 7 to 9, the media transport system 150 comprises a porous filter system 157 disposed below the perforated transport belt 151. In particular, a plurality of non-imaging ink droplets may be jetted through one or more holes 200 of the transport belt and collected by the porous filter system 157, thereby preventing degradation of inkjets that would otherwise go unused. As described herein, the perforated transport belt 151 of this embodiment may be the same as the belt 151 that is described above.

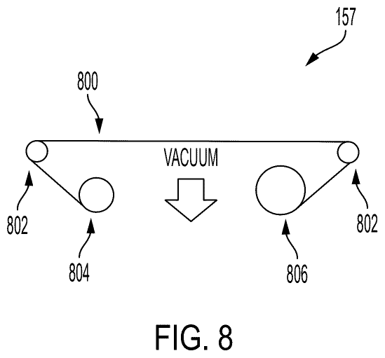

With reference to FIG. 8, a porous filter system 157 can include a porous filter belt 800 mounted over a plurality of rollers 802, 804, 806. The porous filter system 157 can be disposed below the transport belt 151 and the vacuum plate 155 but is configured to allow the vacuum pressure to be applied through the porous filter belt 800. In particular embodiments, the porous filter belt 800 comprises a layer of absorbent material configured to collect a plurality of ink droplets. In embodiments, the porous filter belt 800 may be wound on a first roller 804, unrolled during use, and then re-wound on a second roller 806.

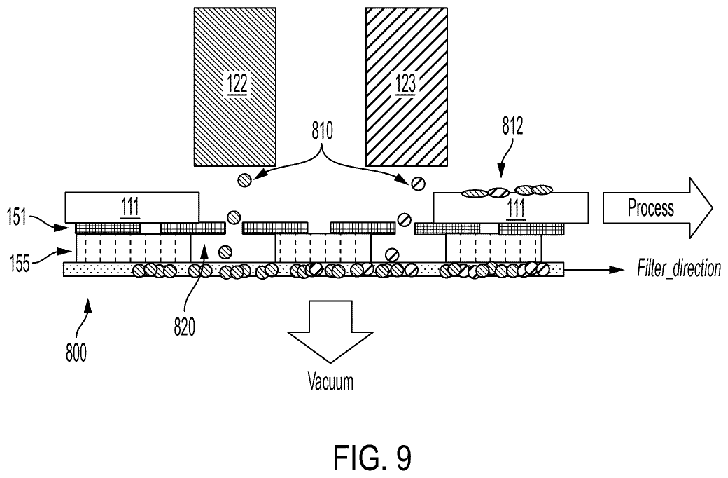

With reference to FIG. 9, the overall process of purging non-imaging inkjets from the printheads 122, 123 is shown in accordance with this embodiment. In particular, print media sheets 111 are disposed on the perforated transport belt 151 and the vacuum plate 155, and the porous filter belt 800 is disposed below the vacuum plate 155. While completing a print job, a plurality of ink droplets 812 will be jetted onto the print media 111 as shown. However, a plurality of non-imaging ink droplets 810 may be timed so as to be jetted through the holes 200 of the transport belt 151 (and the slots 820 of the vacuum plate 155). As a certain region of the porous filter belt 800 is loaded with non-imaging ink droplets 810, the belt 800 may be advanced in a filter direction so as to expose a fresh portion of the belt 800 capable of collecting additional amounts of ink. The filter direction may be the same as the process direction, but it is also contemplated that the filter direction is different from the process direction. By correctly and precisely timing the jetting of these non-imaging ink droplets, the unused inkjets of the printheads (e.g., printheads 122, 123) can be purged thereby preventing degradation in these portions of the printheads.

According to this embodiment, the position of the transport belt 151 may be registered (e.g., via a belt registration sensor 153) and the jetting of non-imaging ink droplets may be timed to perform controlled, non-imaging inkjet purges such that the non-imaging ink droplets pass through the holes 200 of the transport belt 151 without landing on the transport belt 151 itself, thereby preserving inkjet health and preventing degradation of the inkjet performance.

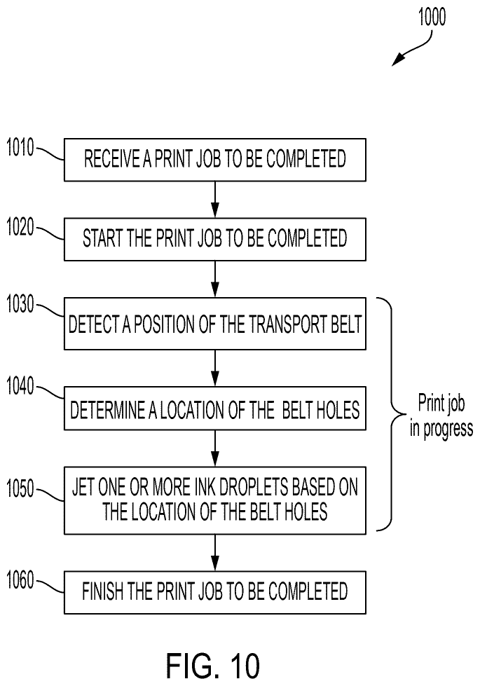

Also provided herein are methods for achieving the same using the printing systems 100 and media transport systems 150. For example, with reference to FIG. 10, a method 1000 for preserving inkjet health in an inkjet printing system is illustrated in accordance with certain aspects of the present disclosure. As shown, the method 1000 can include: in a step 1030, detecting a position of a transport belt of the inkjet printing system; in a step 1040, determining a location of one or more transport belt holes in the transport belt based on the detected position; and in a step 1050, jetting one or more non-imaging ink droplets through the one or more transport belt holes in the transport belt based on the determined locations thereof. In embodiments, the method 1000 can also include: in a step 1010, receiving a print job to be completed by the printing system; in a step 1020, starting the print job to be completed; performing steps 1030-1050 while the print job is in progress; and in a step 1060, finishing the print job to be completed.

According to aspects of the present disclosure, the step 1010 can include receiving a print job to be completed, wherein the print job involves printing on a narrow print media or continuous short edge printing. As such, at least a portion of one or more printheads will have a region of inkjets that go unused while completing the print job.

In the step 1020, the method 1000 can include starting the print job to be completed, which can include transferring sheets of suitable print media from a feeder module 110 to the print engine 120 via the media transport system 150.

In the step 1030, the position of the transport belt 151 of the media transport system 150 can be registered, i.e., precisely located. In embodiments, a belt registration sensor 153 may be used to detect the position of the transport belt 151.

In the step 1040, the location of one or more holes or holes 200 of the transport belt 151 are determined and tracked. In embodiments, the printer controller 160 can store the specifications of the transport belt 151, including the precise layout of the holes 200 relative to the belt registration sensor 153. In particular embodiments, the location of one or more purge holes of the transport belt 151 may be determined. Notably, the steps 1030 and 1040 may be performed repeatedly throughout the printing process in order to prevent calculation drift and ensure maximum accuracy. In particular embodiments, it can be determined when one or more holes 200 (e.g., purge holes 202A, 202B) of the transport belt 151 will align with one or more purge plenums 208.

In the step 1050, the method 1000 can then include jetting one or more non-imaging ink droplets 810 from one or more inactive inkjets through the holes 200 of the transport belt 151. In embodiments, the non-imaging ink droplets 810 may be collected by an ink-collecting means disposed below the transport belt 151, such as a purge platform 156 and/or a porous filter system 157. As described, these non-imaging ink droplets 810 may be jetted while the printing process for the print job is ongoing.

Then, in the step 1060, the method 1000 can include finishing the print job. In embodiments, this can include providing the print media to the ink drying module 130, the output module 140, and/or a finishing module.

As described herein, the methods 1000 may find particular application in an inkjet printing system 100 that is a cut-sheet inkjet printing system, such as a production inkjet system like the Xerox Baltoro™ HF Inkjet Press. The method 1000 may find further application in connection with short edge or narrow media printing wherein one or more printheads have an inboard section of inkjets that go unused for extended periods of time during a print job.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

As used herein, although the terms first, second, third, etc. may be used herein to describe various elements or components, these elements or components should not be limited by these terms. These terms are only used to distinguish one element or component from another element or component. Thus, a first element or component discussed below could be termed a second element or component without departing from the teachings of the inventive concept.

Unless otherwise noted, when an element or component is said to be “connected to,” “coupled to,” or “adjacent to” another element or component, it will be understood that the element or component can be directly connected or coupled to the other element or component, or intervening elements or components may be present. That is, these and similar terms encompass cases where one or more intermediate elements or components may be employed to connect two elements or components. However, when an element or component is said to be “directly connected” to another element or component, this encompasses only cases where the two elements or components are connected to each other without any intermediate or intervening elements or components.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

It should also be understood that, unless clearly indicated to the contrary, in any methods claimed herein that include more than one step or act, the order of the steps or acts of the method is not necessarily limited to the order in which the steps or acts of the method are recited.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium comprises the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, comprising an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, comprising a local area network (LAN) or a wide area network (WAN), or the connection can be made to an external computer (for example, through the Internet using an Internet Service Provider). In some examples, electronic circuitry comprising, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture comprising instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

What is claimed is:

1. A method for preserving inkjet health in an inkjet printing system comprising a media transport module configured to transport a print media substrate through a print zone and an inkjet printhead configured to eject ink droplets from one or more inkjet nozzles in the print zone, the method comprising:
detecting, via the inkjet printing system, a position of a transport belt of the media transport module;
determining, based on the detected position of the transport belt, a location of a transport belt hole of the transport belt; and
ejecting, from the one or more inkjet nozzles of the printhead, an ink droplet based on the determined location of the transport belt hole of the transport belt;
wherein the ink droplet is ejected such that the ink droplet passes through the transport belt hole of the transport belt.

2. The method of claim 1, comprising:
determining, based on the detected position of the transport belt, a location of a plurality of transport belt holes of the transport belt; and
ejecting, from the one or more inkjet nozzles of the printhead, a plurality of ink droplets based on the determined locations of the plurality of transport belt holes of the transport belt;
wherein each ink droplet of the plurality of ink droplets is ejected such that the ink droplet passes through one of the plurality of transport belt holes of the transport belt.

3. The method of claim 1, wherein the transport belt comprises a plurality of transport belt holes arranged linearly in a cross-process direction and extend across at least a portion of the transport belt corresponding to an inboard portion of the printhead.

4. The method of claim 1, wherein the inkjet printing system comprises a belt registration sensor configured to detect the position of the transport belt of the media transport module.

5. The method of claim 1, comprising:
receiving, by the inkjet printing system, a print job to be completed by the inkjet printing system;
completing the print job by:
transporting one or more print media substrates through the print zone based on the received print job; and
ejecting, from the one or more inkjet nozzles of the printhead, a plurality of ink droplets onto the one or more print media substrates within the print zone; and
while completing the print job:
determining, based on the print job, an inactive inkjet nozzle among the one or more inkjet nozzles; and
ejecting, from the inactive inkjet nozzle, a non-imaging ink droplet based on the determined location of the transport belt hole of the transport belt;
wherein the non-imaging ink droplet is ejected from the inactive inkjet nozzle such that the non-imaging ink droplet passes through the transport belt hole of the transport belt.

6. The method of claim 5, wherein the inactive inkjet nozzle is determined by:
calculating a projected duration of non-use for each of the one or more inkjet nozzles during the print job; and
identifying each of the one or more inkjet nozzles having a projected duration of non-use that exceeds a threshold, wherein at least one inkjet nozzle has a projected duration of non-use that exceeds the threshold and is identified as the inactive inkjet nozzle.

7. An inkjet printing system comprising:
a media transport module comprising a transport belt and configured to transport a print media substrate through a print zone of the inkjet printing system;
an inkjet printhead comprising a plurality of inkjet nozzles and configured to eject ink droplets from the plurality of inkjet nozzles in the print zone; and
a print engine operatively connected to the media transport module and the inkjet printhead, wherein the print engine comprises one or more processors in communication with a non-transitory computer-readable storage medium having stored thereon instructions that, when executed by the one or more processors, cause the inkjet printing system to perform the following operations:
detect a position of the transport belt of the media transport module;
determine, based on the detected position of the transport belt, a location of a transport belt hole of the transport belt; and
eject, from at least one inkjet nozzle of the plurality of inkjet nozzles, an ink droplet based on the determined location of the transport belt hole of the transport belt;
wherein the ink droplet is ejected such that the ink droplet passes through the transport belt hole of the transport belt.

8. The inkjet printing system of claim 7, wherein the non-transitory computer-readable storage medium further comprises instructions stored thereon that, when executed by the one or more processors, cause the inkjet printing system to perform the following operations:
determine, based on the detected position of the transport belt, a location of a plurality of transport belt holes of the transport belt; and
eject, from the at least one inkjet nozzle of the plurality of inkjet nozzles, a plurality of ink droplets based on the determined locations of the plurality of transport belt holes of the transport belt;
wherein each ink droplet of the plurality of ink droplets is ejected such that the ink droplet passes through one of the plurality of transport belt holes of the transport belt.

9. The inkjet printing system of claim 7, wherein the transport belt comprises a plurality of transport belt holes arranged in linearly in a cross-process direction.

10. The inkjet printing system of claim 9, wherein the plurality of transport belt holes extend across only a portion of the transport belt corresponding to an inboard portion of the printhead.

11. The inkjet printing system of claim 9, wherein the plurality of transport belt holes extend across an entire width of the transport belt.

12. The inkjet printing system of claim 7, further comprising a belt registration sensor configured to detect the position of the transport belt of the media transport module.

13. The inkjet printing system of claim 7, wherein the media transport module further comprises:
one or more air blowers configured to apply a vacuum pressure through the transport belt in order to secure the print media substrate to the transport belt;
a vacuum plate disposed below the transport belt and having a plurality of holes and/or slots, the vacuum plate being configured to support the transport belt while maintaining the vacuum pressure; and
a purge platform disposed below the vacuum plate and comprising one or more cross-process purge plenums configured to collect one or more ink droplets ejected through the transport belt hole of the transport belt.

14. The inkjet printing system of claim 13, wherein the purge platform and the one or more cross-process purge plenums are stationary during operation of the inkjet printing system.

15. The inkjet printing system of claim 7, wherein the media transport module further comprises:
one or more air blowers configured to apply a vacuum pressure through the transport belt in order to secure the print media substrate to the transport belt;
a vacuum plate disposed below the transport belt and having a plurality of holes and/or slots, the vacuum plate being configured to support the transport belt while maintaining the vacuum pressure;
a porous filter belt disposed below the vacuum plate within the print zone, wherein the porous filter belt comprises a porous ink-absorbing material configured absorb one or more ink droplets ejected through the transport belt hole of the transport belt whiling maintain the vacuum pressure.

16. The inkjet printing system of claim 15, wherein the porous filter belt is movable relative to the vacuum plate and the transport belt such that different portions of the porous filter belt may be exposed to the print zone at different times.

17. A media transport module for use in an inkjet printing system, the media transport module comprising:
a transport belt comprising a plurality of transport belt holes, wherein the transport belt is configured to transport a print media substrate through a print zone of the inkjet printing system;
one or more air blowers configured to apply a vacuum pressure through the transport belt in order to secure the print media substrate to the transport belt;
a vacuum plate disposed below the transport belt and having a plurality of holes and/or slots, the vacuum plate being configured to support the transport belt while maintaining the vacuum pressure; and
an ink-collecting means disposed below the vacuum plate and configured to collect one or more ink droplets ejected by a printhead of the inkjet printing system and received through a transport belt hole of the plurality of transport belt holes.

18. The media transport module of claim 17, wherein the ink-collecting means comprises:
a purge platform disposed below the vacuum plate and comprising one or more cross-process purge plenums configured to collect one or more ink droplets ejected through the transport belt hole of the transport belt;
wherein the purge platform and the one or more cross-process purge plenums are stationary.

19. The media transport module of claim 17, wherein the ink-collecting means comprises:
a porous filter belt disposed below the vacuum plate within the print zone, wherein the porous filter belt comprises a porous ink-absorbing material configured absorb one or more ink droplets ejected through the transport belt hole of the transport belt whiling maintain the vacuum pressure;
wherein the porous filter belt is movable relative to the vacuum plate and the transport belt such that different portions of the porous filter belt may be exposed to the print zone at different times.

20. The media transport module of claim 17, wherein the ink-collecting means extends across at least a portion of the transport belt corresponding to an inboard portion of the printhead, and/or
wherein the ink-collecting means extends across an entire width of the transport belt.
